(19) United States
(12) Patent Application Publication
(10) Pub. No.: US 2023/0042106 A1
(43) Pub. Date: Feb. 9, 2023

(54) SYSTEM AND METHOD FOR THE STATISTICAL ANALYSIS OF IMAGES OF PHOTOVOLTAIC PANELS

(71) Applicant: UNIVERSIDAD TÉCNICA FEDERICO SANTA MARÍA, Valparaíso (CL)

(72) Inventors: Rodrigo Sebastián BARRAZA VICENCIO, Ñuñoa, Santiago (CL); Patricio VALDIVIA LEFORT, Providencia, Santiago (CL); Jorge Esteban SALAS GORDÓNIZ, Conchalí, Santiago (CL); Federico Antonio CASTILLO BURNS, Peñalolén, Santiago (CL)

(21) Appl. No.: 17/784,063

(22) PCT Filed: Dec. 9, 2019
(86) PCT No.: PCT/CL2019/050136

§ 371 Date: Jun. 9, 2022

(51) Int. Cl. H02S 50/00; G06T 7/00; G06T 7/90

(52) U.S. Cl. CPC H02S 50/00; G06T 7/0004; G06T 7/90; G06T 2207/30108; G06T 2207/10024

(57) ABSTRACT

A system and method for statistical analysis of PV photovoltaic panel images for quantifying the percentage of reduction of electricity generation or the percentage of electricity generation of PV photovoltaic panels due to the soiling level of PV photovoltaic panels by means of a system for statistical analysis of PV photovoltaic panel images, using a camera capable of photographing the panels in the visible spectrum, a clean and properly functioning PV photovoltaic panel without the presence of soiling, shading, or operational faults, a string of soiled PV photovoltaic panels to be evaluated, a computer and an method for image analysis.

### FIELD OF APPLICATION

The present invention relates to a system and method for quantifying the reduction of electricity generation of PV photovoltaic panels or modules due to the soiling level of said PV photovoltaic panels by means of a system and method for the statistical analysis of images of PV photovoltaic panels.

### DESCRIPTION OF PRIOR ART

Patent application JP2017034932 (A) dated 9 Feb. 2017, by SAKURAZAWA TOSHIYA et al., entitled MAINTENANCE METHOD FOR PHOTOVOLTAIC POWER GENERATION FACILITY, describes taking a visible image and then analyzing the brightness of the image by evaluating the “contamination state of the panels” according to the assigned value of brightness, thus determining whether or not a photovoltaic panel array needs to be cleaned.

Patent application US2018331653 (A1) dated 15 Nov. 2018, by GOSTEIN MICHAEL et al, entitled OPTICAL SOILING MEASUREMENT DEVICE FOR PHOTOVOLTAIC ARRAYS, describes the comparison of a signal value before and after passing through a soiled transparent window by detecting the fraction of light scattered and reflected due to the accumulated dirt.

Patent JP6362750 (B1) dated 25 Jul. 2018, by SATO YASUSHI et al., entitled ABNORMAL PLACE DETECTION SYSTEM, describes the use of images to detect anomalies, superimposing the image to be analyzed with a “drawing” to evaluate whether the outlines of the “drawing” and the image match, thus detecting an anomaly.

Patent application US2016233830 (A1) dated 11 Aug. 2016, by KOUNO TORU et al., entitled SOLAR POWER GENERATION SYSTEM AND FAILURE DIAGNOSIS METHOD THEREFOR, describes the use of electrical variables and generation prediction by means of a model and measurement of the solar resource to detect anomalies in strings of photovoltaic panels.

None of the documents cited above describe a system and method for quantifying the percentage of reduction of electricity generation or the percentage of electricity generation of PV photovoltaic panels due to the soiling level of PV photovoltaic panels by means of a system for the statistical analysis of PV photovoltaic panel images using a camera capable of photographing the panels in the visible spectrum, a clean and properly functioning PV photovoltaic panel with no soiling, shading, or operational faults, a string of soiled PV photovoltaic panels to be evaluated, a computer, and a method for image analysis.

### SUMMARY OF THE INVENTION

A first objective of the invention is to provide a system for statistical analysis of images of PV photovoltaic panels, where for quantifying the percentage of electricity generation in electric power plants using PV photovoltaic panels, it consists of an image capturing device, which can be a photographic camera or a video camera, which allows capturing images in the visible spectrum, which delivers the images captured in the visible spectrum to an analysis computer, where the image capturing device captures an image of a soiled panel or string of PV photovoltaic panels to be evaluated; where the captured images are sent to the analysis computer, which performs a statistical analysis of the pixels of the captured image and determines a digital soiling value according to the soiling level of the panel or string of PV photovoltaic panels, where a low digital soiling value that tends to zero refers to the color black, meaning that a panel or string of PV photovoltaic panels is clean; and a higher digital soiling value with a maximum of 255 refers to the color white.

A second objective of the invention is to provide a method for statistical analysis of the images of PV photovoltaic panels, comprising: obtaining input data, where an analysis computer receives input data from a weather station and the photograph of a string of panels or modules of PV photovoltaic panels from an image capturing device to quantify the percentage of reduction of electricity generation of said PV photovoltaic panels due to the soiling levels; the analysis computer processes the data obtained of the PV photovoltaic panels in clean condition and at different soiling levels over time, captured by the image capturing device; calculating a digital soiling value from the available solar radiation and spectrum coming from the PV photovoltaic panels in clean condition and at different soiling levels under various solar radiations and environmental conditions, where the analysis computer evaluates the frequency of the digital values of each pixel for the images obtained for the panel or string of PV solar panels in a PV electric power plant; calculating the percentage of electricity generation due to the soiling of PV photovoltaic panels, applying a correlation of the previously obtained generation percentage and estimating a percentage of electricity generation lost due to soiling, for the evaluated panel or string of PV photovoltaic panels; calibrating the percentage of electricity generation, where the correlation of the generation percentage applied to obtain the percentage of electricity generation must be calibrated on site to better estimate the percentage of electricity production of the panel or string of PV photovoltaic panels; and performing a calibration process that adjusts the percentage of electricity generation based on the digital soiling value, a value that is specific to the season and geographical area where the photovoltaic electric power plant is located.

### BRIEF DESCRIPTION OF THE FIGURES

FIG. 1 describes the system for quantifying the percentage of electricity generation of PV photovoltaic panels due to soiling.

FIG. 2 describes the method for correlating the digital value of images and the electricity generation of PV photovoltaic panels due to soiling.

FIG. 3 describes the method used for quantifying the percentage of electricity generation.

FIG. 4 describes the method used for calculating the correlation of reduction of electricity generation.

### DETAILED DESCRIPTION OF A PREFERRED EMBODIMENT

An objective of the invention is to quantify the percentage of electricity generation in electric power plants using PV photovoltaic panels, due to the soiling level of the PV photovoltaic panels, by means of a system for statistical analysis of images of PV photovoltaic panels. The system comprises a camera capable of photographing PV photovoltaic panels in the visible spectrum, a clean and properly functioning PV photovoltaic panel without the presence of soiling, shading, or operational faults, a string of soiled PV photovoltaic panels to be evaluated, a computer, and a method for image analysis.

The invention is applicable to the operation and maintenance of power plants using PV photovoltaic panels. The cost of cleaning and the use of resources is high; many plants using PV photovoltaic panels only monitor the actual electricity generation and do not have models of potential generation, or what they should be producing if the PV photovoltaic panels were clean and free of faults, so they are not able to optimize cleaning, since they cannot quantify how much energy they stop generating due to the soiling deposited on the PV photovoltaic panels. Currently, cleaning routines are established by intuition and/or with the frequency established in cleaning contracts.

The method for quantifying the percentage of electricity generation in electric power plants using PV photovoltaic panels, due to the soiling level of PV photovoltaic panels, considers a comparison of the digital values of pixels from images of soiled and clean PV photovoltaic panels, evaluating the distribution of both images and the frequency of values of each pixel. As inputs, the method has the images in the visible spectrum, the electrical variables from the SCADA system, and environmental variables from a weather station, such as local temperature, wind, and local solar radiation. In this way, it is possible to estimate the power loss of the electric power plant using PV photovoltaic panels, due to the soiling of said PV photovoltaic panels, thus providing information that allows to determine whether or not it is appropriate to clean the PV photovoltaic panels.

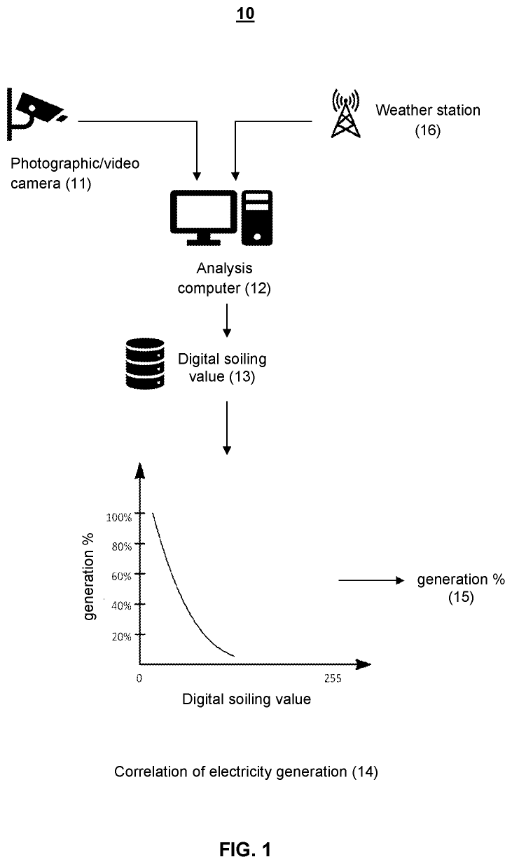

FIG. 1 describes a system for statistical analysis of images of PV photovoltaic panels (10), for quantifying the percentage of electricity generation in electric power plants using PV photovoltaic panels, comprising an image capturing device (11), which may be a photographic camera or a video camera, which allows to capture images in the visible spectrum, which delivers the images captured in the visible spectrum to an analysis computer (12), where the image capturing device (11) captures an image of a soiled panel or string of PV photovoltaic panels to be evaluated; where the captured images are sent to the analysis computer (12). A statistical analysis of the image pixels is performed and a digital soiling value (13) corresponding to the soiling of the panel or string of PV photovoltaic panels is determined. A low digital soiling value (13) that tends to zero refers to the color black and in this case to a clean panel or string of PV photovoltaic panels.

The more soiling a panel or string of PV photovoltaic panels accumulates, the higher its digital value becomes, with the maximum value 255 referring to the color white. The digital soiling value (13) has a generation correlation (14) with respect to the generation capacity of the panel or string of PV photovoltaic panels. This generation correlation (14) is determined according to the method for quantifying the percentage of electricity generation in electric power plants using PV photovoltaic panels, as described below. The digital soiling value (13) by using the generation correlation (14) allows estimating a percentage of electricity generation (15) from the panel or string of PV photovoltaic panels.

A weather station (16) or a reference cell allows to compare that the images are captured under similar illumination conditions as the conditions at which the generation correlation (14) was obtained.

### Obtaining the Correlation:

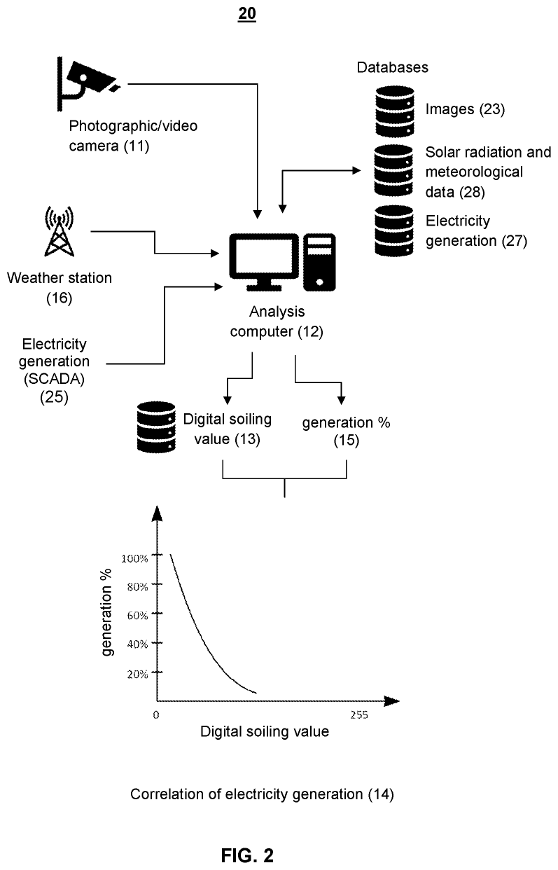

FIG. 2 describes how the correlation of electricity generation (14) is obtained, which allows estimating the percentage of electricity generation (15) in electric power plants using PV photovoltaic panels due to the soiling level of the PV photovoltaic panels.

The correlation of the generation percentage (14) can be obtained with on-site data, either in a PV photovoltaic plant or in a laboratory. In both cases, the method consists of a first stage where the images are captured, by means of an image capturing device (11), which may be a photographic camera or video camera or similar, which allows capturing images in the visible spectrum; a second stage consists of delivering the images captured in the visible spectrum to an analysis computer (12), where the image capturing device (11) captures images of a panel or modules of PV photovoltaic panels, from their clean condition to different soiling levels. The captured images are sent to the analysis computer (12) and stored in an image memory (23). The stored images (23) are statistically analyzed and their digital soiling values (13), corresponding to the soiling of a panel or modules of PV photovoltaic panels, are determined and stored. Simultaneously to the image capturing, by means of the image capturing device (11), the electrical variables of the SCADA system (25) and the solar radiation obtained from the weather station, or the reference cell (26), are recorded. The electricity generation variables (27) obtained from the weather station or reference cell (26) are stored in the analysis computer (12). From the stored electricity generation variables (27) and the solar radiation, a percentage of electricity generation (15) using PV photovoltaic panels due to soiling in said PV photovoltaic panels can be estimated. A statistical analysis is performed to determine the correlation under similar illumination conditions between the digital soiling value (13) and the percentage of electricity generation (15) of the panel or string of PV photovoltaic panels. Thus, this correlation of the generation percentage (14) allows estimating the power loss of the electric power plant using PV photovoltaic panels due to soiling in said PV photovoltaic panels.

### Operational Description (Power Loss Calculation in the Plant)

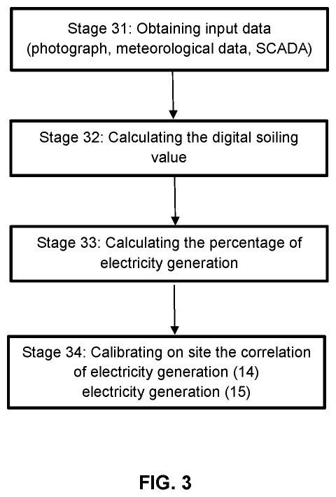

The method for quantifying the percentage of electricity generation in electric power plants using PV photovoltaic panels, due to the soiling level of PV photovoltaic panels, can be divided into the following stages, which are shown in FIG. 3:

Stage 31: Obtaining Input Data:

The analysis computer (12) receives the input data from the weather station and the photograph of the string, panel, or modules of PV photovoltaic panels from the image capturing device (11) to quantify the percentage of electricity generation of the PV photovoltaic panels due to soiling level. The analysis computer (12) processes the data obtained for the PV photovoltaic panels in clean condition and at different soiling levels over time, captured by the image capturing device (11);

Stage 32: Calculating Digital Soiling Value (13):

From the available solar radiation and spectrum coming from the PV photovoltaic panels from their clean condition and at different soiling levels under various radiation and environmental conditions, the analysis computer (12) evaluates the frequency of digital values of each pixel for the images obtained for the panel or string of PV solar panels in the PV electric power plant;

Stage 33: Calculating the Percentage of Electricity Generation Due to Soiling of PV Photovoltaic Panels:

The correlation of the previously obtained generation percentage (14) is applied and the percentage of electricity generation (15) due to soiling is estimated for the panel or string of PV photovoltaic panels evaluated.

Stage 34: Calibration of the Percentage of Electricity Generation (15):

The correlation of the generation percentage (14) applied for obtaining the percentage of electricity generation (15) should be calibrated on site to better estimate the percentage of electricity production of the panel or string of PV photovoltaic panels. The composition of dust particles and pollutants (soiling) precipitating on the panel or string of PV photovoltaic panels evaluated in different geographical areas and seasons of the year is variable. Thus, it is necessary to perform a calibration process that adjusts the percentage of electricity generation (15) based on the digital soiling value (13), a value that is specific to the season and geographical area where the photovoltaic power plant is located. To perform this process, the analysis computer (12) receives the following data:
digital soiling value (13)
reduced correlation value of electricity generation (14)
solar resource and meteorological data from a weather station (16)
electrical data from the SCADA power generation system (25) of a soiled panel or string of PV photovoltaic panels
electrical data from the SCADA power generation system (25) of a clean panel or string of PV photovoltaic panels.

The analysis computer (12) uses the digital soiling value (13) obtained from the images of the panel or string of PV photovoltaic panels under study to obtain the percentage of electricity generation (15) by means of the electricity generation correlation (14). Then, it corrects the percentage of electricity generation (15) of the correlation of electricity generation (14) with the percentage of electricity generation measured on site, for each evaluated digital value and for given solar radiation and environmental conditions. This process is performed for the entire spectrum of digital values present in the PV photovoltaic panel plant evaluated, thus obtaining a correlation of reduced generation calibrated on site.

### Operational Description (Obtaining the Correlation)

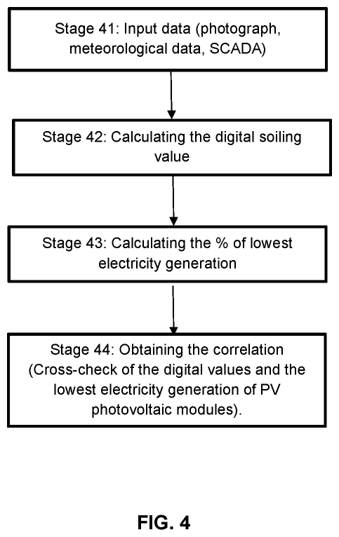

The method used to obtain the correlation of electricity generation (14) related to the digital soiling value (13). It is performed in the same plant using PV photovoltaic panels (in situ) or in a laboratory, as shown in FIG. 4.

Stage 41: Input data: The input data supplied to the analysis computer (12), are:
images of solar panels or strings of PV photovoltaic panels in clean condition and at different soiling levels, captured by the image capturing device (11). The minimum capture interval of the images is related to the digital soiling value (13), which may be days or weeks.
data of the electrical variables from the SCADA power generation system (25),
solar radiation from the weather station (16) or reference cell.

These input variables are stored in the memory (23), meteorological database (28), and electricity generation database (27).

Stage 42: Calculating the Digital Soiling Value (13):

From the solar radiation available from the weather station (16) and the spectrum from the images obtained by the image capturing device (11) of the PV photovoltaic panels in clean condition and at different soiling levels, the frequency of the digital value of each pixel is evaluated by storing the data obtained in the database of the digital soiling values (13) for each image obtained.

Stage 43: Calculating the Percentage of Electricity Generation (15):

From the database of electricity generation variables (27), the electrical production of the soiled string of PV photovoltaic panel is compared with the electrical production of the clean string of PV photovoltaic panel for various soiling conditions. Obtaining the percentage of electricity generation (15) of the string of soiled panels based on the soiling of the panel or string of PV photovoltaic panels.

Stage 44: Obtaining the Correlation of Electricity Generation (14):

A cross-check of the stored variables is performed:
meteorological database (28)
digital soiling value (13)
percentage of electricity generation (15)

Relating the previously calculated digital soiling value (13) with the percentage of electricity generation (15) of the panel or string of PV photovoltaic panels (under similar environmental and solar radiation conditions).

In this way, a correlation of electricity generation (14) is constructed between a theoretical percentage of electricity generation (where clean is a 100%) and the coloration or digital soiling value (13) of the panel or string of PV photovoltaic panels.

A low digital soiling value (13) that tends to zero refers to the color black and in this case to a clean panel or string of PV photovoltaic panels. The more soiling a panel or string of PV photovoltaic panels accumulates, the higher its digital value becomes, with the maximum value 255 referring to the color white. The digital soiling value (13) has a correlation of electricity generation (14) with respect to the generation capacity (or percentage) of the panel or string of PV photovoltaic panels.

In addition, in stage 31 the analysis computer (12) commands the image acquisition by the image capturing device (11), where the image obtained may be stored or reviewed without saving. Once the image is obtained, the panels are automatically segmented or selected by detecting the corners, shape, panel color, or background removal, which allows determining which pixels of the image are contained in the PV panels.

Each of the pixels have three associated values according to the intensity level: red, blue, and green. Thus, a statistical analysis is performed for the distribution of the intensity values in the population of pixels for each panel. From these populations, the different percentiles and averages associated with each panel observed in the photograph or photographs of the plant panels are obtained.

In addition, different images associated to each of the RGB images are generated to obtain images in the grayscale, XYZ, YCrCb, LUV, HLS, HSV, LAB, and YUV color models, which allow associating each pixel to three other intensity values for each of the models. Using these color models (including RGB), the characteristics values that distinguish a clean panel from a soiled one are obtained, using the same methods of statistical data processing as with the RGB color model.

In addition to this, the intensity values in the color models are related to a soiled panel and a clean panel (using both panels as a reference), to calibrate the production loss of the panels, and to establish the relationship between soiling and power values.

This relationship is then extended for each of the panels in the future images, to obtain the expected generation results, which allows to estimate the generation loss of the plant, as well as the economic loss of the plant due to reduced production, to establish the best time to clean the panels.

Finally, the periodic evaluation of PV photovoltaic panels allows to determine the future evolution of soiling, which may improve the preparations for maintenance.

What is claimed is:

1. A system (10) for statistical analysis of images of PV photovoltaic panels, CHARACTERIZED in that, for quantifying the percentage of electricity generation in electric power plants using PV photovoltaic panels, it comprises an image capturing device (11), which may be a photographic camera or a video camera, which allows to capture images in the visible spectrum, which delivers the images captured in the visible spectrum to an analysis computer (12), where the image capturing device (11) captures an image of a soiled panel or string of PV photovoltaic panels to be evaluated; where the captured images are sent to the analysis computer (12), which performs a statistical analysis of the pixels of the captured image and determines a digital soiling value (13) corresponding to the soiling of the panel or string of PV photovoltaic panels, where a low digital soiling value (13) that tends to zero refers to the color black and in this case to a clean panel or string of PV photovoltaic panels; and a higher digital soiling value (13) with a maximum of 255 refers to the color white.

2. The system (10) according to claim 1, CHARACTERIZED in that, in addition, the digital soiling value (13) has a generation correlation (14) with respect to the generation capacity of the panel or string of PV photovoltaic panels, where this generation correlation (14) is determined according to a method for quantifying the percentage of electricity generation in electric power plants using PV photovoltaic panels, and a weather station (16) or a reference cell allows comparing that the images are captured under similar illumination conditions as the conditions at which the generation correlation (14) was obtained; and that it allows to estimate the percentage of electricity generation (15) in power plants using PV photovoltaic panels due to the soiling level of the PV photovoltaic panels.

3. The system (10) according to claim 1, CHARACTERIZED in that, in addition, the captured images are stored in an image memory (23), which are statistically analyzed and their digital soiling values (13), corresponding to the soiling of a panel or modules of PV photovoltaic panels, are determined and stored.

4. The system (10) according to claim 3, CHARACTERIZED in that, simultaneously with capturing images by means of the image capturing device (11), electrical variables are registered from a SCADA system (25) and solar radiation obtained from the weather station or reference cell (26), and electricity generation variables (27) obtained from the weather station or reference cell (26) are stored in the analysis computer (12).

5. The system (10) according to claim 3, CHARACTERIZED in that, from the stored electricity generation variables (27) and solar radiation, a percentage of electricity generation (15) by PV photovoltaic panels due to soiling on said PV photovoltaic panels can be estimated, a statistical analysis is performed to determine the correlation under similar illumination conditions between the digital soiling value (13) and the percentage of electricity generation (15) of the panel or string of PV photovoltaic panels, thus, this correlation of generation percentage (14) allows to estimate the power loss of the electric power plant using PV photovoltaic panels due to soiling of said PV photovoltaic panels.

6. The system (10) according to claim 5, CHARACTERIZED in that the correlation of generation percentage (14) is obtained with on-site data, both in a PV photovoltaic plant and in a laboratory.

7. A method (10) of statistical analysis of images of PV photovoltaic panels, CHARACTERIZED in that it comprises:
obtaining input data, where an analysis computer (12) receives input data from a weather station and the photograph of a string of panels or modules of PV photovoltaic panels from an image capturing device (11) to quantify the percentage of electricity generation of said PV photovoltaic panels due to the soiling level; the analysis computer (12) processes the data obtained for the PV photovoltaic panels in clean condition and at different soiling levels over time, captured by the image capturing device (11);
calculating a digital soiling value (13) from the available solar radiation and spectrum coming from the PV photovoltaic panels in their clean condition and at different soiling levels under various radiation and environmental conditions, where the analysis computer (12) evaluates the frequency of digital values of each pixel for the images obtained for the panel or string of PV solar panels in a PV electric power plant;
calculating the percentage of electricity generation due to the soiling of PV photovoltaic panels, applying a correlation of the previously obtained generation percentage (14) and estimating a percentage of electricity generation (15) due to soiling for the evaluated panel or string of PV photovoltaic panels;
calibrating the percentage of electricity generation (15), where the correlation of generation percentage (14) applied to obtain the percentage of electricity generation (15) must be calibrated on site to better estimate the percentage of electricity production of the panel or string of PV photovoltaic panels; and performing a calibration process that adjusts the percentage of electricity generation (15) based on the digital soiling value (13), a value that is specific to the season and geographical area where the photovoltaic electric power plant is located.

8. A method (10) according to claim 7, CHARACTERIZED in that the analysis computer (12) receives the following data:
digital soiling value (13),
reduced correlation value of electricity generation (14),
solar resource and meteorological data from a weather station (16),
electrical data from a SCADA power generation system (25) of a soiled panel or string of PV photovoltaic panels,
electrical data from the SCADA power generation system (25) of a clean panel or string of PV photovoltaic; where,
the analysis computer (12) uses the digital soiling value (13) obtained from the images of the evaluated panel or string of PV photovoltaic panels to obtain the percentage of electricity generation (15) by means of the correlation of electricity generation (14), and corrects the percentage of electricity generation (15) from the correlation of electricity generation (14) with the percentage of electricity generation measured on site, for each evaluated digital value and for given solar radiation and environmental conditions.

9. A method (10) according to claim 7, CHARACTERIZED in that for obtaining the correlation of electricity generation (14) relating to the digital soiling value (13), the following steps are performed:
input data, the input data of the analysis computer (12), are:
images of a panel or string of PV photovoltaic panels in clean condition and at different soiling levels captured by the image capturing device (11), with a minimum capture interval of the images that is related to the digital soiling value (13), which may be days or weeks;
data of the electrical variables from a SCADA power generation system (25),
solar radiation from the weather station (16) or reference cell,
these input variables are stored in an image memory (23), a meteorological database (28), and an electricity generation database (27);
calculating the digital soiling value (13) from the solar radiation measured by the weather station (16) and the spectrum from the images obtained by the image capturing device (11) of the PV photovoltaic panels in clean condition and at different soiling levels, evaluating the frequency of the digital value of each pixel by storing the data obtained in the database of the digital soiling values (13) for each image obtained;
calculating the percentage of electricity generation (15), from the database of the electricity generation variables (27), the electrical production of the soiled string of PV photovoltaic panels is compared with the production of electrical energy of the clean string of PV photovoltaic panels, for various soiling conditions, thus obtaining the percentage of electricity generation (15) of the soiled string of panels due to soiling of the panel or string of PV photovoltaic panels;
obtaining the correlation of electricity generation (14), performing a cross-check of the stored variables:
meteorological database (26),
digital soiling value (13),
percentage of electricity generation (15),
correlating the previously calculated digital soiling value (13) with the percentage of electricity generation (15) of the panel or string of PV photovoltaic panels (under similar environmental and solar radiation conditions).

10. A method (10) according to claim 1, CHARACTERIZED in that a low digital soiling value (13) that tends to zero refers to the color black and in this case to a clean panel or string of PV photovoltaic panels, and as more soiling a panel or string of PV photovoltaic panels accumulates, its digital value is higher, where the maximum value 255 refers to the color white.

11. A method (10) according to claim 7, CHARACTERIZED in that, in addition, the analysis computer (12) commands the acquisition of the image by the image capturing device (11), where the obtained image may be stored or reviewed without saving; once the image is obtained, the panels are automatically segmented or selected by detecting the edges, shape, panel color, or background removal, which allows determining the pixels of the image that contain the panel; each of the pixels have three associated values, related to the intensity level of red, blue, and green, thus, a statistical analysis is performed for the distribution of intensity values in the population of pixels for each panel. From these populations, the different percentiles and averages associated with each panel observed in the photograph or photographs of the plant panels are obtained.

12. A method (10) according to claim 6, CHARACTERIZED in that, in addition, different images are generated associated to each of the images in RGB, to obtain images in the grayscale, XYZ, YCrCb, LUV, HLS, HSV, LAB, and YUV color models, which allow to associate each pixel with three other intensity values for each of the color models, where these models (including RGB) are used to obtain the characteristics of values that determine a clean panel from a soiled one, using the same statistical data processing methods as with the RGB color model.
